(19) United States
(12) Patent Application Publication
(10) Pub. No.: US 2011/0096831 A1
(43) Pub. Date: Apr. 28, 2011

(54) IMAGE ENCODING DEVICE, IMAGE ENCODING METHOD, AND IMAGING SYSTEM

(75) Inventor: Kentaro TAKAKURA, Osaka (JP)

(73) Assignee: PANASONIC CORPORATION, Osaka (JP)

(21) Appl. No.: 12/979,938

(22) Filed: Dec. 28, 2010

Related U.S. Application Data
(63) Continuation of application No. PCT/JP2009/003308, filed on Jul. 14, 2009.

(30) Foreign Application Priority Data
Sep. 29, 2008 (JP) 2008-251111

(51) Int. Cl. H04N 7/26

(52) U.S. Cl. 375/240.03; 375/E07.139

(57) ABSTRACT

An image encoding device for generating a plurality of portions of encoded data from the same input image data, includes a moving image encoding processor configured to compress/encode image data, an amount-of-encoded-data detector configured to detect the amount of first encoded data generated, a conversion table configured to determine a multiplier to be multiplied by a quantization parameter based on the detected amount of the first encoded data so that the moving image encoding processor generates second and subsequent encoded data, and an amount-of-encoded-data controller configured to determine a quantization parameter for obtaining target amounts of the second and subsequent encoded data, based on the determined multiplier.

### CROSS-REFERENCE TO RELATED APPLICATIONS

This is a continuation of PCT International Application PCT/JP2009/003308 filed on Jul. 14, 2009, which claims priority to Japanese Patent Application No. 2008-251111 filed on Sep. 29, 2008. The disclosures of these applications including the specifications, the drawings, and the claims are hereby incorporated by reference in their entirety.

### BACKGROUND

The present disclosure relates to devices and methods for encoding images by compression (encoding), and imaging systems.

As digital still cameras and digital camcorders have become widespread, the joint photographic experts group (JPEG) standard and the moving picture experts group (MPEG) standard, which are techniques of compressing (encoding) image data, have been commonly used. Also, networks, such as the Internet, etc., have rapidly become widely available, and network cameras including surveillance cameras, and television telephones are becoming more and more popular. The number of users which can be simultaneously connected to a network, however, increases with an increase in the bandwidth of the network, and therefore, the amount of data which can be transmitted or received is limited. Therefore, service providers have studied a control method for reducing the data amount.

There is a conventional technique of reducing the deviation of data amounts occurring when a plurality of portions of encoded data having different bit rates are generated from the same image data by performing an offset control with respect to the timing of start of compression (encoding) processes performed on a frame-by-frame basis by a plurality of encoding processors. A multiplexing processor performs transmission at equal intervals within a unit time, depending on the amount of each portion of encoded data generated within the unit time by a plurality of encoding processors (see Japanese Patent Publication No. 2004-140651.

In conventional image encoding devices, the amount of encoded data generated by an encoding processor is detected by an amount-of-encoded-data detector, the detected amount of encoded data is compared with a target encoded data amount which is previously set, and when the detected amount of encoded data exceeds the target encoded data amount, a quantization table is updated so that a quantized coefficient is reduced or the number of quantized coefficients which are evaluated as zero increases. Thereafter, the updated quantization table is used to quantize data. The quantized data is encoded. The amount of the encoded data is compared with the target encoded data amount. These processes are repeated until the amount of encoded data becomes lower than the predetermined target encoded data amount, thereby reducing the amount of data. Therefore, updating of the quantization table, quantization, and encoding are repeatedly performed, resulting in a delay in data transfer and a decrease in the frame rate of moving images.

Specifically, for example, in the case of network cameras, etc., when a sudden change occurs in an image (e.g., somebody enters a field monitored by the camera), the amount of data to be encoded increases. In this case, the amount of encoded data may suddenly increase and exceed the target encoded data amount, resulting in frame dropping, etc.

### SUMMARY

The present disclosure describes implementations of an image encoding device and an image encoding method capable of reducing the number of times of quantization to increase the speed of a compression (encoding) process.

An example image encoding device for generating a plurality of portions of encoded data from the same input image data, includes an image encoding processor configured to compress/encode image data, an amount-of-encoded-data detector configured to detect the amount of first encoded data generated, and an amount-of-encoded-data controller configured to determine a quantization parameter for obtaining target amounts of second and subsequent encoded data, based on the amount of encoded data detected by the amount-of-encoded-data detector.

The example image encoding device may further include a conversion table configured to determine a multiplier to be multiplied by a quantization parameter based on the detected amount of the first encoded data so that the image encoding processor generates second and subsequent encoded data. In this case, the amount-of-encoded-data controller can determine a quantization parameter for obtaining target amounts of the second and subsequent encoded data, based on the determined multiplier.

Thus, by determining a multiplier for a quantization parameter for generating the second and subsequent encoded data with reference to the amount of the first encoded data using the conversion table, and based on the determined multiplier, determining a quantization parameter for obtaining target amounts of the second and subsequent encoded data, the amounts of the second and subsequent encoded data can be reduced before quantization and encoding for generation of the second and subsequent encoded data.

Moreover, in the example image encoding device, the amount-of-encoded-data detector has a function of detecting the amount of the second and subsequent encoded data. As a result, when the third and subsequent encoded data are generated, an appropriate quantization parameter can be determined based on the amounts of the first or second encoded data.

According to the present disclosure, a quantization parameter is controlled before quantization and encoding, whereby the number of times of processing can be reduced, resulting in an increase in the speed of compression (encoding) of image data.

### BRIEF DESCRIPTION OF THE DRAWINGS

FIG. 1 is a block diagram showing an imaging system according to an embodiment of the present disclosure.

FIG. 2 is a block diagram showing an embodiment of the image encoding device of FIG. 1.

FIG. 3 is a block diagram showing another embodiment of the image encoding device of FIG. 1.

FIG. 4 is a diagram showing an example of discrete cosine transform (DCT) coefficients obtained by the configurations of FIGS. 2 and 3.

FIGS. 5A-5C are diagrams showing specific example conversion tables for the configuration of FIG. 3.

FIG. 6 is a timing diagram showing an order in which encoding is performed in the configuration of FIG. 3.

### DETAILED DESCRIPTION

Embodiments of the present disclosure will be described hereinafter with reference to the accompanying drawings.

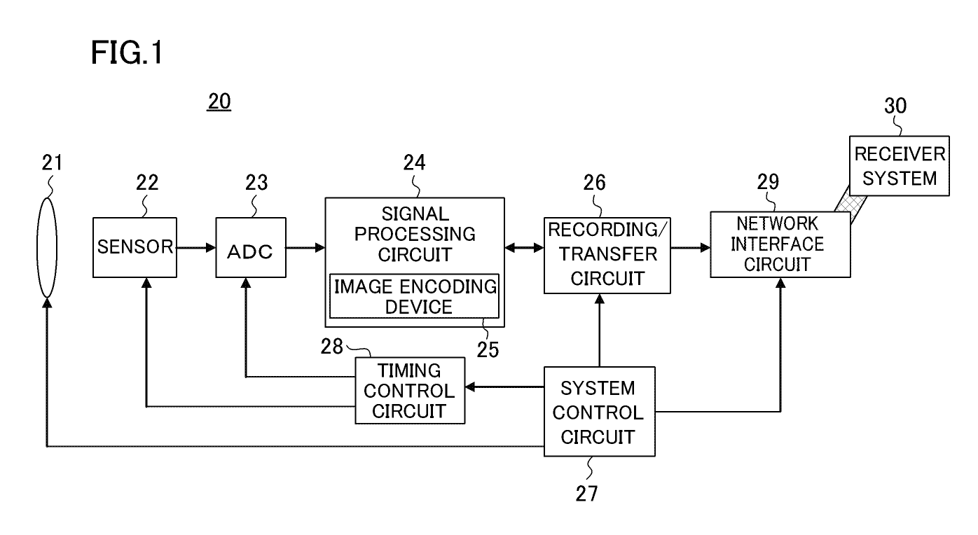

FIG. 1 is a block diagram showing an imaging system (e.g., a network camera) 20 according to an embodiment of the present disclosure. In FIG. 1, the imaging system 20 includes an optical system 21, an imaging sensor 22, an analog-to-digital converter (ADC) 23, a signal processing circuit 24, an image encoding device 25, a recording/transfer circuit 26, a system control circuit 27, a timing control circuit 28, and a network interface circuit 29. A reference character 30 indicates a receiver system. The entire imaging system 20 of FIG. 1 is controlled by the system control circuit 27.

In the imaging system 20 of FIG. 1, an image of a subject entering through the optical system 21 is formed on the imaging sensor 22. The imaging sensor 22 is driven by the timing control circuit 28 to accumulate and convert optical data of the formed subject image into an electrical signal (photoelectric conversion). The electrical signal read out from the imaging sensor 22 is converted into a digital signal by the ADC 23, and the digital signal is input to the signal processing circuit 24, which includes the image encoding device 25. The signal processing circuit 24 performs image processing, such as a Y/C separation process, an edge process, an image enlargement/reduction process, a compression (encoding) process according to the present disclosure, etc. After the image processing, the resultant image data is recorded into a medium or transferred to a network by the recording/transfer circuit 26. The transferred image data is transmitted to the receiver system 30 by the network interface circuit 29.

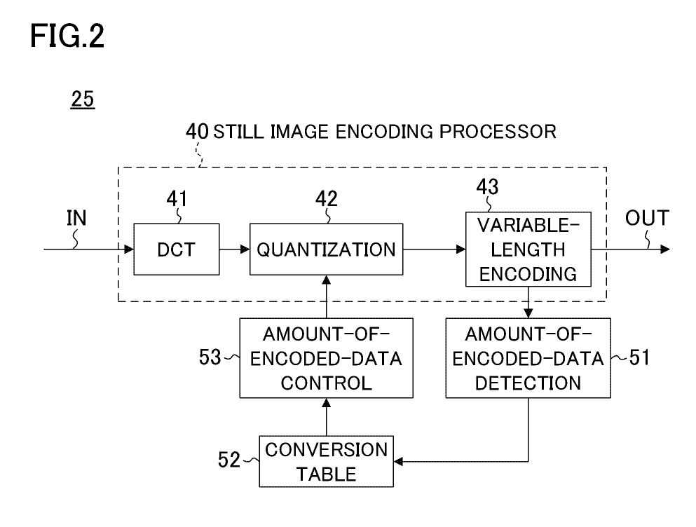

FIG. 2 is a block diagram showing an embodiment of the image encoding device 25 of FIG. 1 in the case of JPEG. The image encoding device 25 of FIG. 2 includes a still image encoding processor 40, an amount-of-encoded-data detector 51, a conversion table 52, and an amount-of-encoded-data controller 53. The still image encoding processor 40 includes a DCT unit 41 which successively receives pixel data (input image data IN) on a block-by-block basis where each block includes 8×8 pixels, and performs orthogonal transform with respect to the pixel data, a quantizer 42 which quantizes the orthogonally transformed data from the DCT unit 41, and a variable-length encoder 43 which encodes the quantized data from the quantizer 42 to supply output encoded data OUT.

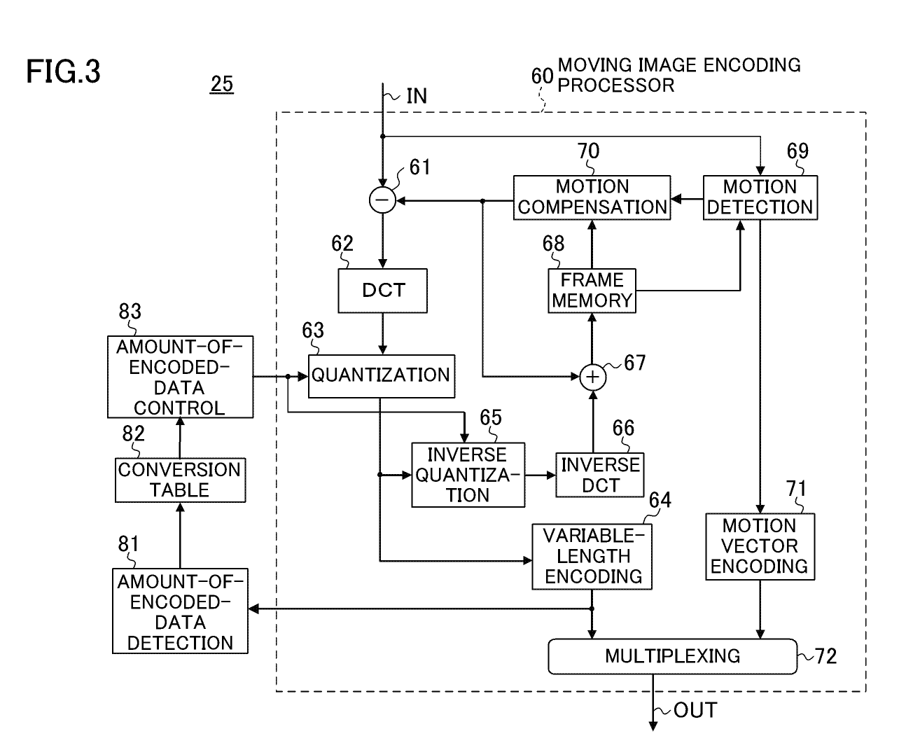

FIG. 3 is a block diagram showing an embodiment of the image encoding device 25 of FIG. 1 in the case of MPEG. The image encoding device 25 of FIG. 3 includes a moving image encoding processor 60, an amount-of-encoded-data detector 81, a conversion table 82, and an amount-of-encoded-data controller 83. The moving image encoding processor 60 includes a predictive error generator 61, a DCT unit 62, a quantizer 63, a variable-length encoder 64, an inverse quantizer 65, an inverse DCT unit 66, a reconstructed image generator 67, a frame memory 68, a motion detector 69, a motion compensator 70, a motion vector encoder 71, and a multiplexer 72. The moving image encoding processor 60 successively receives pixel data (input image data IN) on a block-by-block basis where each block includes 8×8 pixels, and outputs output encoded data OUT from the multiplexer 72.

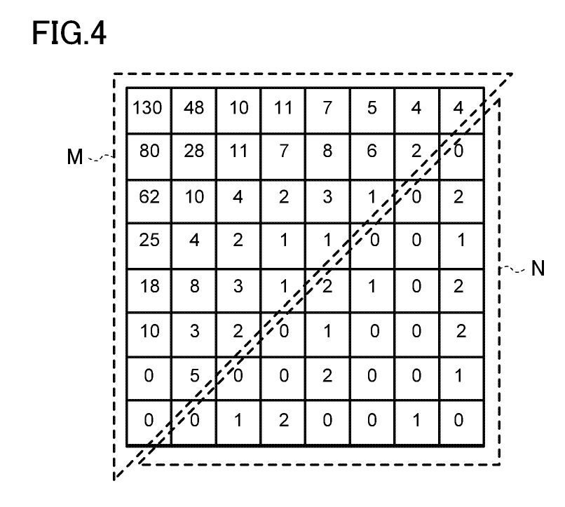

FIG. 4 is a diagram showing an example of DCT coefficients obtained by the configurations of FIGS. 2 and 3. In general, color smoothly changes over almost all portions of a natural image. Therefore, in the DCT coefficient distribution of FIG. 4 which is generated by orthogonal transform, DCT coefficients having larger values are concentrated in a low-frequency region M, while DCT coefficients having smaller values are distributed in a high-frequency region N.

According to the configuration of FIG. 2, the DCT unit 41 obtains DCT coefficients, such as those shown in FIG. 4. The quantizer 42 divides the DCT coefficients by a quantization parameter previously set in the quantization table to generate quantized coefficients. By this process, the values of quantized coefficients in the high-frequency region N, which does not have an influence on image quality, are caused to be 0 (zero), whereby quantized coefficients are concentrated in the low-frequency region M. Next, the variable-length encoder 43 assigns code words having different lengths, depending on the frequencies of appearance of combinations of the numbers of portions of data having a value of 0 (zero) and the values of the quantized coefficients, thereby compressing (encoding) the image data.

In addition, the encoded data obtained by the variable-length encoder 43 is input to the amount-of-encoded-data detector 51, which then obtains the amount of the encoded data. The amount-of-encoded-data controller 53 calculates a multiplier for the quantization parameter from the conversion table 52 based on the amount of the encoded data obtained in the amount-of-encoded-data detector 51, and determines the quantization parameter from the multiplier.

On the other hand, in the configuration of FIG. 3, encoding is performed using intra-frame correlation or inter-frame correlation to obtain I-frames, P-frames, and B-frames.

In the case of I-frames, the output of the quantizer 63 is also input to the inverse quantizer 65, and then transferred through the inverse DCT unit 66 to the reconstructed image generator 67. The result of the motion compensator 70 is also simultaneously input to the reconstructed image generator 67. If a block is of inter-frame correlation, both the portions of input data are added and the result is written to the frame memory 68. In the case of I-frames, however, blocks are only of intra-frame correlation, the result of the motion compensator 70 is not input to the reconstructed image generator 67. Therefore, the data transferred from the inverse DCT unit 66 is directly written to the frame memory 68. This image data transferred to the frame memory 68 is referred to as a reconstructed image, which is used as a reference image for P-frames or B-frames.

In the case of P-frames and B-frames, image data is input on a block-by-block basis, and transferred to the predictive error generator 61 and the motion detector 69. The motion detector 69 receives the input image data, reads out pixel data in the vicinity of the same spatial position as that of the input image data from the frame memory 68, and performs motion search for obtaining a pixel position which has a highest correlation with the input image data. Thereafter, the motion detector 69 transfers the image data having the highest correlation as retrieved reference image data to the motion compensator 70, and at the same time, transfers a motion vector indicating the position to the motion vector encoder 71. Here, when intra-frame correlation encoding is selected, the subsequent encoding processes are similar to those for I-frames. When inter-frame correlation encoding is selected, the reference image data is transferred via the motion compensator 70 to the predictive error generator 61, which then calculates a difference between the input image data and the reference image data and outputs the difference to the DCT unit 62. The variable-length encoder 64 encodes the quantized image data, and at the same time, outputs the resultant data along with motion vector data encoded by the motion vector encoder 71 from the multiplexer 72.

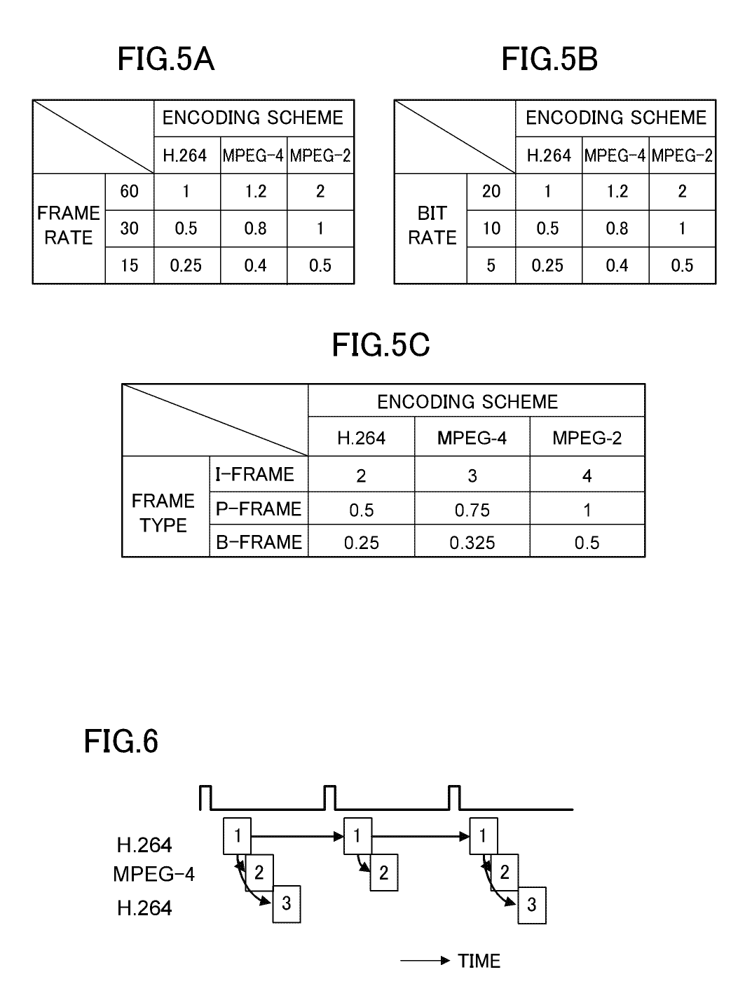

FIG. 5A is a diagram showing a specific example of the conversion table 82 for the configuration of FIG. 3. The conversion table 82 of FIG. 5A shows the values of multipliers to be multiplied by a quantization parameter (first quantization parameter) for encoding of “H.264/60 fps” (hereinafter referred to as first encoding), for frame rates of H.264, MPEG-4, and MPEG-2, where the multiplier value for the first encoding is 1.

In FIG. 3, the encoded data obtained by the variable-length encoder 64 is input to the amount-of-encoded-data detector 81, which then obtains the amount of the encoded data. The amount-of-encoded-data controller 83 calculates, from the amount of the encoded data obtained by the amount-of-encoded-data detector 81, a multiplier for the first quantization parameter based on the conversion table 82 of FIG. 5A, and determines a quantization parameter from the multiplier.

FIG. 6 is a timing diagram showing an order in which multiple streams are encoded in the configuration of FIG. 3. In FIG. 6, “H.264/60 fps” is first encoding, “MPEG-4/60 fps” is second encoding, and “H.264/30 fps” is third encoding. According to FIG. 5A, a multiplier “1.2” is selected for the second encoding, and “the first quantization parameter×1.2” is set to a second quantization parameter, whereby a target encoded data amount for the second encoding can be achieved. A multiplier “0.5” is selected for the third encoding, and “the first quantization parameter×0.5” is set to a third quantization parameter, whereby a target encoded data amount for the third encoding can be achieved. Note that the conversion table 82 may be rewritten by the user.

According to the embodiment of the present disclosure thus configured, for example, it is possible to determine which of the second and third encoded data is larger than the other before the moving image encoding processor 60 generates the second and third encoded data. In other words, the amount of encoded data can be reduced before quantization and encoding.

Although “H.264/60 fps” is the first encoding which is a reference in the above example, other “encoding techniques/frame rates” may be used. Moreover, a multiplier may be calculated from bit rates or frame types instead of frame rates. A case where bit rates are used is shown in FIG. 5B. A case where frame types are used is shown in FIG. 5C.

In FIG. 5C, for example, when a quantization parameter is determined using the amount of encoded data generated in a P-frame of MPEG-2 as a target encoded data amount, the amount of encoded data generated in an I-frame of MPEG-2 is four times as great as that amount of encoded data. On the other hand, the value of a quantization parameter is inversely proportional to the amount of encoded data. Therefore, when an I-frame is encoded, a quantization parameter for a P-frame is multiplied by a multiplier “4,” i.e., increased by a factor of 4, whereby the amount of encoded data generated in the I-frame can be caused to be close to the target encoded data amount.

The imaging processing in the image encoding device 25 of the embodiment of the present disclosure is not necessarily applied to a signal based on a subject image formed on the imaging sensor 22 via the optical system 21, or alternatively, of course, may be applicable to, for example, a case where an image signal input as an electrical signal from an external device is processed.

As described above, according to the present disclosure, the compression (encoding) of an image can be sped up. Therefore, the present disclosure is useful for image encoding devices which require a control for obtaining a predetermined amount of encoded data, such as network cameras including surveillance cameras, television telephones, etc.

What is claimed is:

1. An image encoding device for generating a plurality of portions of encoded data from the same input image data, comprising:
an image encoding processor configured to compress/encode image data;
an amount-of-encoded-data detector configured to detect the amount of first encoded data generated; and
an amount-of-encoded-data controller configured to determine a quantization parameter for obtaining target amounts of second and subsequent encoded data, based on the amount of encoded data detected by the amount-of-encoded-data detector,
wherein
the plurality of portions of encoded data are output from the image encoding processor.

2. An image encoding device for generating a plurality of portions of encoded data from the same input image data, comprising:
an image encoding processor configured to compress/encode image data;
an amount-of-encoded-data detector configured to detect the amount of first encoded data generated;
a conversion table configured to determine a multiplier to be multiplied by a quantization parameter based on the detected amount of the first encoded data so that the image encoding processor generates second and subsequent encoded data; and
an amount-of-encoded-data controller configured to determine a quantization parameter for obtaining target amounts of the second and subsequent encoded data, based on the determined multiplier,
wherein
the plurality of portions of encoded data are output from the image encoding processor.

3. The image encoding device of claim 2, wherein
the amount-of-encoded-data detector further has a function of detecting the amounts of the second and subsequent encoded data,
wherein
the conversion table is used to determine a multiplier for a quantization parameter based on the amounts of the second and subsequent encoded data.

4. The image encoding device of claim 2, wherein
the conversion table is used to determine a multiplier for a quantization parameter based on encoding schemes for the first encoded data and the second and subsequent encoded data.

5. The image encoding device of claim 2, wherein
the conversion table is used to determine a multiplier for a quantization parameter based on frame rates for the first encoded data and the second and subsequent encoded data.

6. The image encoding device of claim 2, wherein
the conversion table is used to determine a multiplier for a quantization parameter based on frame types for the first encoded data and the second and subsequent encoded data.

7. The image encoding device of claim 2, wherein
the conversion table is used to determine a multiplier for a quantization parameter based on bit rates for the first encoded data and the second and subsequent encoded data.

8. The image encoding device of claim 2, wherein
the conversion table is used to determine a multiplier for a quantization parameter based on at least one of or a combination of an encoding scheme, a frame rate, a frame type, and a bit rate.

9. The image encoding device of claim 2, wherein
the image encoding processor includes
an orthogonal transformer configured to successively receive pixel data included in one block and perform orthogonal transform with respect to the pixel data,
a quantizer configured to quantize orthogonally transformed data from the orthogonal transformer, and
an encoder configured to encode quantized data from the quantizer, and the amount-of-encoded-data controller controls the quantization in the quantizer.

10. The image encoding device of claim 2, wherein
the image encoding processor includes
an orthogonal transformer configured to successively receive pixel data included in one block and perform orthogonal transform with respect to the pixel data,
a quantizer configured to quantize orthogonally transformed data from the orthogonal transformer,
an encoder configured to encode quantized data from the quantizer,
an inverse quantizer configured to inversely quantize quantized data from the quantizer,
an inverse orthogonal transformer configured to perform inverse orthogonal transform with respect to inversely quantized data from the inverse quantizer,
a frame memory configured to store inverse orthogonally transformed data from the inverse orthogonal transformer,
a motion detector configured to detect motion based on data from the frame memory and input image data of a current frame,
a motion compensator configured to generate reference image data based on a result of the motion detection from the motion detector, and
a predictive error generator configured to generate a difference between input image data and the reference image data from the motion compensator,
wherein
the amount-of-encoded-data controller controls the quantization in the quantizer and the inverse quantization in the inverse quantizer.

11. An image encoding method for generating a plurality of portions of encoded data from the same input image data using an image encoding device, comprising the steps of:
compressing/encoding image data;
detecting the amount of first encoded data generated;
determining a quantization parameter for obtaining target amounts of second and subsequent encoded data, based on the amount of encoded data detected; and
outputting the plurality of portions of encoded data from the image encoding processor.

12. An imaging system comprising:
a signal processing circuit including the image encoding device of claim 2 and configured to perform signal processing;
a sensor configured to output an image signal to the signal processing circuit; and
an optical system configured to form an image of light on the sensor.

13. The imaging system of claim 12, further comprising:
a converter configured to convert the image signal obtained from the sensor into a digital signal, and supply the digital signal to the signal processing circuit.

14. The imaging system of claim 12, further comprising:
an interface circuit configured to send out encoded data obtained by the image encoding device to a network.
